(19) United States
(12) Patent Application Publication
(10) Pub. No.: US 2004/0082737 A1
(43) Pub. Date: Apr. 29, 2004

(54) Determination of the amount of polymer deposited from (meth) acrylic acid and/or (meth) acrylic esters

(75) Inventors: Frank Hofer, Ludwigshafen (DE); Sylke Haremza, Neckargemuend (DE); Gerhard Wagenblast, Wachenheim (DE); Volker Schliephake, Schifferstadt (DE); Ulrich Jager, Roemerberg (DE); Jurgen Schroder, Ludwigshafen (DE); Harald Keller, Ludwigshafen (DE); Cedric Dieleman, Scheibenhard (FR); Rainer Diehl, Worms (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/651,984

(22) Filed: Sep. 2, 2003

(30) Foreign Application Priority Data
Oct. 23, 2002 (DE) 102 49 507.6

(51) Int. Cl. C08F 2/00

(52) U.S. Cl. 526/59

(57) ABSTRACT

Noninvasive process for inline and/or online determination of polymer deposited from (meth)acrylic acid and/or (meth)acrylic esters by means of sound velocity measurements, measurements of the absorption coefficients in the infrared, near infrared, ultraviolet and/or visible region of the spectrum of electromagnetic radiation, or Raman spectroscopy, which allows precise control of the process parameters to be carried out during the thermal purification.

The present invention relates to a process for determining the amount of polymer deposited preferably from liquid (meth)acrylic acid and/or liquid (meth)acrylic esters.

(Meth)acrylic acids and (meth)acrylic esters are valuable starting compounds for preparing polymers which find use, for example, as adhesives, coatings or dispersions.

In this document, the term (meth)acrylic acid is an abbreviation for methacrylic acid and/or acrylic acid, and (meth)acrylic ester is an abbreviation for methacrylic ester and/or acrylic ester.

To avoid polymerization of (meth)acrylic acid and/or (meth)acrylic ester, stabilizers are used in the thermal purification of liquid (meth)acrylic acid and liquid (meth)acrylic ester.

Nevertheless, polymer deposits occur in the separating apparatus after prolonged running times and force regular shutdown and a costly and inconvenient cleaning of the plant. As is known, this cleaning can be effected mechanically, thermally/oxidatively or by alkali flushing. However, all of these processes are time-consuming and, as a consequence of the plant downtime, also very expensive.

An indicator used for the shutdown of the plant is the decreasing throughput rate or the pressure drop. A determination of the amount of soluble polymers as a measure of the “predamage” of the monomers such as (meth)acrylic acid and/or (meth)acrylic ester or deposition on the column is hitherto unknown.

Among other methods, polymer contents can be determined by the measurement of the propagation rate of sound waves, by the change of the absorption behavior of electromagnetic radiation with, for example, IR, NIR, UV/Vis spectroscopy and also by the change in the emission spectrum recorded by means of Raman spectroscopy.

In J. Appl. Polym. Sci. 2002, 85(12), 2510-2520, Cherfi et al. report fiber-optic NIR measurements for following the homopolymerization of methyl methacrylate in a laboratory reactor.

The same measuring process is used by Vieira et al. in a semibatch reactor for determining the conversion in the emulsion copolymerization of butyl acrylate and methyl methacrylate (J. Appl. Polym. Sci. 2002, 84(14), 2670-2682).

In Polym. Bull. 2002, 47(5), 421-427, Faragalla et al. describe the use of FT-NIR spectroscopy for determining the conversion in the copolymerization of 2-hydroxyethyl methacrylate and N-vinylpyrrolidone.

The use of Raman spectroscopy for following chemical reactions, in particular the selective polymerization of monomers with radical initiators, is described by Adar et al. in Appl. Spectr. Rev. 1997, 32(1-2), 45-101.

In Mol. Phys. 1975, 30(3), 911-919, Jackson et al. describe the use of absorption methods in the thermal polymerization of styrene. This process is followed by Lousberg et al. using NIR spectroscopy (J. Appl. Polym. Sci. 2002, 84(1), 90-98).

Sivakumar et al. in Synth. Metals 2002, 126 (2-3), 123-125 teach the use of UV/Vis spectroscopy for determining kinetic data in the oxidative polymerization of N-methylaniline in dilute sulfuric acid.

DE-A 2 931 282 relates to the continuous measurement of the conversion by ultrasound measurements using the example of the polymerization of vinyl chloride, by determining the changes in the rheological properties such as complex viscosity, average cross section and the shape of the particles in the polymerization system.

DD 159 673 and Dinger et al. in Plaste Kautsch. 1983, 30(12), 665-668 disclose the use of ultrasound measurements in the emulsion polymerization of vinyl acetate.

The determination of the polymer content in liquids by investigating liquid properties is described in DE-A 3 420 794.

Canagello et al. in J. Appl. Polym. Sci. 1995, 57(1), 1333-1346 describe a process for determining the degree of conversion in the homopolymerization of vinyl acetate and of methyl methacrylate with the aid of ultrasound measurements.

Chem. Tech. 1999, 28(3), 30, 33-34 teaches the use of ultrasound measurements in the determination of conversion in liquid systems, especially in polymerization systems.

Ultrasound methods for monitoring the progress of polymerization are used both in the conversion to polyethylene and polypropylene (Plast. Eng. 1999, 55(10), 39-42) and in the bulk polymerization of styrene (Polym. React. Eng. 2000, 8(3), 201-223).

WO-A 00/77515 relates to a process for determining the polymer concentration in the dispersion polymerization of p-phenyleneterephthalamide.

These processes merely show the applicability of the measurement methods in polymerization reactions, i.e. preferably in high concentration regions of the polymers.

A further disadvantage is the described performance in solutions or in emulsions and not in pure substances of the monomers used.

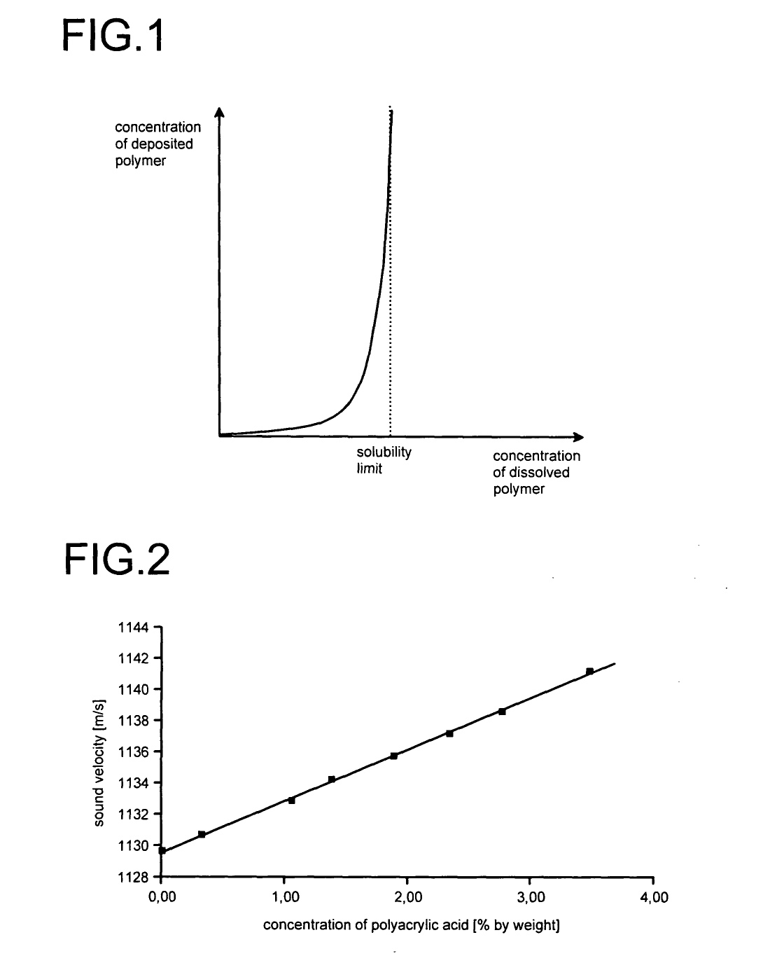

It is known that polymeric deposits are formed by a free-radical reaction of the monomer. This results in polymers being formed whose chain lengths differ greatly. It follows that the deposition of polymeric constituents in thermal separating apparatus is accompanied by the formation of soluble polymer chains (FIG. 1).

It is an object of the present invention to find a process for determining the amount of polymers deposited from liquid (meth)acrylic acid and/or liquid (meth)acrylic esters.

It is a further object of the present invention to find a process for thermally separating (meth)acrylic acid and/or (meth)acrylic esters which allows precise process control, i.e. the optimum adjustment of the operating conditions of the plant, for example type of the stabilizer system, stabilizer concentration, costabilizer concentration, column pressure, bottom temperature and reflux ratio and thus the achievement of less deposition on the column.

It is also an objective to determine the point in time of the shutdown of the plant necessary as a consequence of polymer formation and thus to optimize the economic viability of the plant.

We have found that this object is achieved by a process for determining the amount of polymer deposited from (meth)acrylic acid and/or (meth)acrylic esters, by determining the concentration of polymeric impurities soluble in the monomer by means of online measurements of ultrasound waves, with the aid of changes in the absorption behavior of electromagnetic radiation with, for example, IR, NIR, UV/Vis spectroscopy and also by means of Raman spectroscopy.

For the purposes of this invention, polymers are all compounds of the particular acrylic monomer whose number of monomer units is ≧2.

The process according to the invention preferably finds use during the thermal purification of liquid (meth)acrylic acid and/or liquid (meth)acrylic esters after the preparation or preceding purification steps thereof.

A process has also been found for thermal purification of liquid (meth)acrylic acid and/or liquid (meth)acrylic esters, which comprises determining the content of polymers deposited from liquid (meth)acrylic acid and/or liquid (meth)acrylic esters during the thermal separation noninvasively, i.e. inline without sample withdrawal and/or online, and using the content determined in this way to adjust the operating conditions of the plant.

(Meth)acrylic acid is generally prepared in a manner known per se by heterogeneously catalyzed gas phase partial oxidation of at least one C₃ or C₄ precursor of (meth)acrylic acid. (Meth)acrylic esters are synthesized by acid-catalyzed esterification by methods known to those skilled in the art.

For preparing acrylic acid, C₃-alkanes, -alkenes, -alkanols and/or -alkanals and/or precursors thereof are suitable. Propene, propane, propionaldehyde or acrolein are particularly advantageous. However, useful starting compounds are also those from which the actual C₃ starting compound is not formed until during the gas phase oxidation as an intermediate. When propane is used as a starting material, this can be converted by known processes of catalytic oxydehydrogenation, homogeneous oxydehydrogenation or catalytical dehydrogenation to give a propene/propane mixture. Other suitable propene/propane mixtures are refinery propene (approx. 70% of propene and 30% of propane) or cracker propene (approx. 95% of propene and 5% of propane). When a propene/propane mixture is used to prepare the preferred acrylic acid, propane acts as a diluent gas and/or reactant.

When acrylic acid is prepared, the starting gas is generally diluted with gases which are inert under the chosen conditions, for example nitrogen (N₂), CO₂, saturated C₁-C₆-hydrocarbons and/or steam, and passed in a mixture with molecular oxygen (O₂) or an oxygenous gas at elevated temperatures, typically from 200 to 450° C., and also optionally elevated pressure over transition metal, e.g. Mo- and V-, or Mo-, W-, Bi- and Fe-containing, mixed oxide catalysts and oxidatively converted to acrylic acid. These reactions can be carried out in a plurality of stages or a single stage.

In addition to the desired acid, the resulting reaction gas mixture contains secondary components such as unconverted acrolein and/or propene, steam, carbon monoxide, carbon dioxide, nitrogen, oxygen, acetic acid, propionic acid, formaldehyde, further aldehydes and maleic acid or maleic anhydride. Typically, the reaction gas mixture, based in each case on the entire reaction gas mixture, contains

from 1 to 30% by weight of acrylic acid,

from 0.01 to 1% by weight of propene,

from 0.05 to 1% by weight of acrolein,

from 0.05 to 10% by weight of oxygen,

from 0.01 to 3% by weight of acetic acid,

from 0.01 to 2% by weight of propionic acid,

from 0.05 to 1% by weight of formaldehyde,

from 0.05 to 2% by weight of other aldehydes,

from 0.01 to 0.5% by weight of maleic acid and maleic anhydride,

and also small amounts of acetone and a remainder of inert diluent gases. The inert diluent gases present are in particular saturated C₁-C₆ hydrocarbons, such as methane and/or propane, and in addition steam, carbon oxides and nitrogen.

Methacrylic acid can be prepared in a similar manner from C₄-alkanes, -alkenes, -alkanols and/or -alkanals and/or precursors thereof, for example from tert-butanol, isobutene, isobutane, isobutyraldehyde, methacrolein, isobutyric acid or methyl tert-butyl ether.

Numerous processes are known for removing the (meth)acrylic acid from such a reaction gas mixture. For example, DE-C 2 136 396 or DE-A 2 449 780 disclose the removal of (meth)acrylic acid from the reaction gases obtained in the catalytic gas phase oxidation by countercurrent absorption with a high-boiling hydrophobic solvent. The crude (meth)acrylic acid is distillatively removed from the resulting (meth)acrylic acid-containing mixture. Absorption of (meth)acrylic acid in high-boiling solvents is also described, for example, in DE-A 2 241 714 and DE-A 4 308 087.

Also widely practiced is the absorption of the reaction gas in water or aqueous (meth)acrylic acid solution as the absorbent. Subsequently, the crude (meth)acrylic acid is obtained by distillative separation from the absorbent.

The absorbed (meth)acrylic acid can be subjected to another desorption or stripping process after the absorption or before the distillation, in order to reduce the content of aldehydic or other carbonylic secondary components.

It is equally possible to introduce the gaseous (meth)acrylic acid mixture in other solvents, for example solutions of (meth)acrylic acid in water or high-boiling solvents. These also include solvent mixtures which already have a high proportion of (meth)acrylic acid or other streams of the plant which have been recycled.

It is also possible to introduce the (meth)acrylic acid-containing gas mixture into the column without a stripping procedure.

It is equally possible to carry out absorption and purification in a suitable separating apparatus.

The (meth)acrylic acid mixture which can be used for the process according to the invention is preferably obtained by absorption in diphenyl ether-biphenyl-phthalic ester mixtures, for example in a weight ratio of from 10:90 to 90:10, or from those mixtures to which from 0.1 to 25% by weight (based on the total amount of biphenyl and diphenyl ether) of at least one ortho-phthalic ester, e.g. dimethyl ortho-phthalate, diethyl ortho-phthalate or dibutyl ortho-phthalate, has additionally been added. Preference is likewise given to the use of water as absorbent.

The mixture obtained after absorption generally contains from 10 to 50% by weight of (meth)acrylic acid.

The (meth)acrylic acid absorbed in the absorbent may be directly or indirectly cooled or heated beforehand, for example using a quench, for example spray coolers, Venturi scrubbers, bubble columns or other apparatus having sprayed surfaces, or tube bundle or plate heat exchangers.

(Meth)acrylic esters are widely prepared in a manner known per se by esterification of (meth)acrylic acid with an alcohol, for example an alkanol. (Meth)acrylic esters are generally obtained by a homogeneously or heterogeneously catalyzed esterification, as described, for example, in Kirk Othmer, Encyclopedia of Chemical Technology, 4th Ed., 1994, pages 301-302. A process is described there in which acrylic acid, alkanol and catalyst, for example sulfuric acid, are reacted with recycle streams in a reactor with a fitted reaction column, in which the target ester, excess alkanol and the water formed in the reaction are removed overhead.

Higher (meth)acrylic esters are frequently obtained by transesterification of lower (meth)acrylic esters or likewise by an esterification. Ullmann's Encyclopedia of Industrial Chemistry, 6th Ed., 2000 Electronic Release, Chapter: Acrylic Acid and Derivatives—Esterification, describes a process for preparing higher alkyl acrylates which is performed in the presence of an organic solvent as an azeotroping agent and sulfuric acid as a catalyst. The water formed in the reaction is removed by an azeotropic distillation.

DE-A 1 468 932, 2 226 829 and 2 252 334 describe processes for preparing alkyl (meth)acrylates by reacting (meth)acrylic acid with monohydric alcohols having from 1 to 5 carbon atoms in a homogeneous liquid phase at elevated temperature and in the presence of proton-donating catalysts.

Further processes for preparing (meth)acrylic esters are described, for example, in DE-A 19 604 252, DE-A 19 604 253, GB-1 017 522, U.S. Pat. No. 4,280,010, DE-A 19 935 453, DE-A 19 851 983 and EP-A 779 268 and the literature cited therein.

Preferred preparative processes for (meth)acrylic esters are described in DE-A 102 46 869 and DE-A 101 44 490.

The acidic catalysts which can be used are preferably sulfuric acid, p-toluenesulfonic acid, benzenesulfonic acid, dodecylbenzenesulfonic acid, methanesulfonic acid or mixtures thereof, although acidic ion exchangers are also conceivable.

Particular preference is given to using sulfuric acid, p-toluenesulfonic acid and methanesulfonic acid, very particular preference to sulfuric acid and p-toluenesulfonic acid.

The catalyst concentration based on the reaction mixture is, for example, from 1 to 20% by weight, preferably from 5 to 15% by weight.

Alcohols suitable for the reaction are those which have from 1 to 8 carbon atoms.

Preference is given to methanol, ethanol, n-propanol, isopropanol, n-butanol, isobutanol, dimethylaminoethanol and 2-ethylhexanol, particular preference to methanol, ethanol, n-butanol, dimethylaminoethanol and 2-ethylhexanol.

The separating apparatus into which the (meth)acrylic acidand/or (meth)acrylic ester-containing mixture is conducted may be a distillation, rectification, absorption or desorption column, or a column for fractional condensation.

For the process according to the invention, preference is given to thermal separating apparatus such as distillation and rectification columns or equipment for cooling the absorption mixture of interest. These are of known design and have separating internals and at least one means of condensation in the top region or apparatus comprising a plurality of apparatuses connected in series for cooling the absorption mixture.

Useful column internals are in principle any common internals, in particular trays, structured packings and/or random packings. Among the trays, preference is given to bubble-cap trays, sieve trays, valve trays, Thormann trays and/or dual-flow trays, and among the random packings, preference is given to those comprising rings, spirals, saddles, Raschig, Intos or Pall rings, barrels or Intolax saddles, Top-Pak, etc., or braids. It will be appreciated that combinations of separating internals are also possible.

Typically, the total number of theoretical plates in the column is from 5 to 100, preferably from 10 to 80, more preferably from 20 to 80 and most preferably from 30 to 70.

In the case of a rectification column, the operating pressure in the column is generally from 10 mbar to atmospheric pressure, preferably from 20 mbar to atmospheric pressure, more preferably from 20 to 800 mbar and most preferably from 20 to 500 mbar.

The feed of the (meth)acrylic acid- and/or (meth)acrylic ester-containing mixture is generally in the lower half of the column, preferably in the lower third.

The reflux at which the column is operated may, for example, be from 100:1 to 1:100, preferably from 50:1 to 1:50, more preferably from 20:1 to 1:20 and most preferably from 10:1 to 1:10.

The gas loading factor F of such a column is typically in the range from 1 to 3 Pa^{0.5}, preferably from 1.5 to 2.5 Pa^{0.5}. The liquid hourly space velocity is typically in the range from 1 to 50 m/h, preferably from 2 to 10 m/h.

The mixture to be separated in the column is customarily stabilized with at least one stabilizer. This at least one stabilizer can additionally be added to the column with the (meth)acrylic acid- and/or (meth)acrylic ester-containing mixture and/or during the separation, for example with a reflux stream.

Examples of suitable stabilizers include phenolic compounds, N-oxyl compounds, aromatic amines, phenylenediamines, amines, sulfonamides, oximes, oxime ethers, hydroxylamines, urea derivatives, phosphorus compounds, sulfur compounds, complexing agents based on TAA (tetraazaannulene) and metal salts, and also optionally mixtures thereof.

Examples of phenolic compounds include phenol, alkylphenols, for example o-, m- or p-cresol (methylphenol), 2-tert-butyl-4-methylphenol, 2,6-di-tert-butyl-4-methyl-phenol, 2-tert-butylphenol, 4-tert-butylphenol, pyrocatechol (1,2-dihydroxybenzene), 2-tert-butyl-6-methylphenol, 2,4,6-tris-tert-butylphenol, 2,6-di-tert-butylphenol, 2,4-di-tert-butylphenol, 4-tert-butyl-2,6-dimethylphenol, 2-methyl-4-tert-butylphenol, octylphenol [140-66-9], nonylphenol [11066-49-2], 2,6-dimethylphenol, 2,6-di-tert-butyl-p-cresol, bisphenol A, Irganox® 565, 1010, 1076, 1141, 1192, 1222 and 1425 from Ciba Spezialitätenchemie, tert-butylcatechol, p-aminophenol, p-nitrosophenol, alkoxyphenols, for example 2-methoxyphenol (guaiacol, pyrocatechol monomethyl ether), tocopherols, quinones and hydroquinones, for example hydroquinone, methylhydroquinone, 4-methoxyphenol (hydroquinone monomethyl ether), 2,5-di-tert-butylhydroquinone, 2-methyl-p-hydroquinone, tert-butylhydroquinone, benzoquinone.

Examples of N-oxyls (nitroxyl or N-oxyl radicals, i.e. compounds containing at least one >N—O. group) include 4-hydroxy-2,2,6,6-tetramethylpiperidine N-oxyl, 4-oxo-2,2,6,6-tetramethylpiperidine N-oxyl, 4-methoxy-2,2,6,6-tetramethylpiperidine N-oxyl, 2,2,6,6-tetramethylpiperidine N-oxyl or Uvinul® 4040P from BASF Aktiengesellschaft.

Aromatic amines are, for example, N,N-diphenylamine, N-nitrosodiphenylamine, nitrosodiethylaniline, phenylenediamines are, for example, N,N′-dialkyl-p-phenylenediamine, where the alkyl radicals may be the same or different and may each independently contain from 1 to 4 carbon atoms and may be linear or branched, for example, N,N′-diisobutyl-p-phenylenediamine.

Examples of imines include methyl ethyl imine, (2-hydroxyphenyl)benzoquinone imine, (2-hydroxyphenyl)benzophenone imine, N,N-dimethylindoaniline, thionine (7-amino-3-imino-3H-phenothiazine), methylene violet (7-dimethylamino-3-phenothiazinone).

Examples of sulfonamides effective as stabilizers include N-methyl-4-toluenesulfonamide, N-tert-butyl-4-toluenesulfonamide, N-tert-butyl-N-oxyl-4-toluenesulfonamide, N,N′-bis(4-sulfanilamide)piperidine, 3-{[5-(4-aminobenzoyl)-2,4-dimethylbenzenesulfonyl]ethylamino}-4methylbenzenesulfonic acid, as described in DE-A 102 58 329.

Oximes may, for example, be aldoximes, ketoximes or amidoximes, as described, for example, in DE-A 101 39 767, and preference is given to diethyl ketoxime, acetone oxime, methyl ethyl ketoxime, cyclohexanone oxime, dimethyl glyoxime, 2-pyridine aldoxime, salicyl aldoxime or other aliphatic or aromatic oximes or their reaction products with alkyl transfer reagents.

Hydroxylamines are, for example, N,N-diethylhydroxylamine.

Urea derivatives are, for example, urea or thiourea.

Phosphorus compounds are, for example, triphenylphosphine, triphenyl phosphite, hypophosphorous acid, trinonyl phosphite or triethyl phosphite.

Sulfur compounds are, for example, diphenyl sulfide, phenothiazine and sulfur-containing natural products such as cysteine.

Examples of complexing agents based on tetraazaannulene (TAA) include dibenzotetraaza[14]annulenes and porphyrins, as specified in Chem. Soc. Rev. 1998, 27, 105-115.

Examples of metal salts include copper, manganese, cerium, nickel, chromium carbonate, chloride, dithiocarbamate, stearate, sulfate, salicylate, acetate or ethylhexanoate.

Preferred stabilizers are phenothiazine, o-, m- or p-cresol (methylphenol), 2-tert-butyl-4-methylphenol, 2,6-di-tert-butyl-4-methylphenol, 2-tert-butylphenol, 4-tert-butylphenol, 2,4-di-tert-butylphenol, pyrocatechol (1,2-dihydroxybenzene), 2,6-di-tert-butylphenol, 4-tert-butyl-2,6-dimethylphenol, octylphenol [140-66-9], nonylphenol [11066-49-2], 2,6-dimethylphenol, 2,6-di-tert-butyl-p-cresol, bisphenol A, tert-butylcatechol, hydroquinone, hydroquinone monomethyl ether or methylhydroquinone, and also manganese(II) acetate, cerium(III) carbonate, cerium(III) acetate or cerium(III) ethylhexanoate, cerium(III) stearate and also mixtures thereof in different compositions.

Particular preference is given to phenothiazine, o-, m- or p-cresol (methylphenol), 2-tert-butyl-4-methylphenol, 2,6-di-tert-butyl-4-methylphenol, 4-tert-butylphenol, 2,4-di-tert-butylphenol, 4-tert-butyl-2,6-dimethylphenol, pyrocatechol (1,2-dihydroxybenzene), octylphenol [140-66-9], nonylphenol [11066-49-2], 2,6-dimethylphenol, 2,6-di-tert-butyl-p-cresol, tert-butylcatechol, hydroquinone, hydroquinone monomethyl ether or methylhydroquinone, and also cerium(III) acetate, cerium(III) ethylhexanoate or cerium(III) stearate and mixtures thereof in different compositions.

Very particular preference is given to phenothiazine, o-, m- or p-cresol (methylphenol), 2,6-di-tert-butyl-4-methylphenol, 4-tert-butylphenol, 4-tert-butyl-2,6-dimethylphenol, octylphenol [140-66-9], nonylphenol [11066-49-2], 2,6-dimethylphenol, 2,6-di-tert-butyl-p-cresol, tert-butylcatechol, hydroquinone, hydroquinone monomethyl ether or methylhydroquinone and also cerium(III) acetate or cerium(III) ethylhexanoate and mixtures of at least two of the components mentioned.

The way in which the stabilizer is added is not limited. The stabilizer can be added individually or as a mixture, in liquid or in dissolved form in a suitable solvent which may itself be a stabilizer, as described, for example, in DE-A 102 00 583.

The stabilizer may, for example, be added in a suitable formulation at any desired point in the column, to an external cooling circuit or to a suitable reflux stream. Preference is given to adding directly into the column or to a reflux stream.

When a mixture of a plurality of stabilizers is used, these may be fed independently at different metering points or at the same metering point as mentioned above, or else independently, dissolved in different solvents.

The stabilizers can also be used advantageously together with a compound familiar as a costabilizer, for example with oxygenous gases.

Depending on the individual substance, the stabilizer concentration in the column may be between 1 and 10 000 ppm, preferably between 10 and 5000 ppm, more preferably between 30 and 2500 ppm and in particular between 50 and 1500 ppm. In the region of the sidestream takeoffs, the stabilizer concentration is preferably at from 100 to 1000 ppm.

In a particularly preferred manner, the dissolved stabilizer (mixture) is sprayed onto any column internals, individual trays of the separating apparatus or column lid present.

The process according to the invention preferably finds use during the thermal purification of the (meth)acrylic acid- and/or (meth)acrylic ester-containing mixture. The crude (meth)acrylic acid and/or crude (meth)acrylic ester withdrawn from the columns may have any desired purities which are not important to the invention, for example at least 90% by weight, preferably at least 93% by weight, more preferably at least 94% by weight, based in each case on the entire reaction mixture. The value for the purity of the material to be tested is constant over the duration of the measurement.

In addition to acrylic acid, the preferred crude acrylic acid withdrawn as middle boilers at the sidestream takeoff also comprises secondary components which are generally

from 0.05 to 2% by weight of lower carboxylic acids, e.g. acetic acid

from 0.01 to 5% by weight of water

from 0.01 to 1% by weight of lower molecular weight aldehydes, e.g. benzaldehyde, furfural

from 0.01 to 1% by weight of maleic acid and/or its anhydride

from 1 to 500 ppm of stabilizer,

based in each case on the weight of the crude acrylic acid.

In addition to at least 93.2% by weight of (meth)acrylic ester (based on the entire reaction mixture), the crude (meth)acrylic ester withdrawn overhead also comprises secondary components. In general, these are condensation products of alcohols with each other formed under acid conditions, impurities of the monomers used and alcohols or secondary components of the ester preparation.

The process according to the invention for determining the amount of polymer deposited from liquid (meth)acrylic acid and/or liquid (meth)acrylic esters is preferably part of an overall process for preparing (meth)acrylic acid and/or (meth)acrylic esters. For the preparation process, the same applies as was said above.

Polymeric precontamination of liquid (meth)acrylic acid and/or liquid (meth)acrylic esters and its progress as a function of time are detected by ultrasound measurements and also by all common optical analytical methods, preferably ultrasound measurements, IR, NIR and UV/Vis spectroscopy and also Raman spectroscopy.

These methods are preferably noninvasive processes which enable determination of the polymer content inline and/or online.

It will be appreciated that the methods according to the invention can also be carried out invasively, i.e. by access into the system, for example sample-taking, and the content of polymer can be determined discontinuously.

The invasive offline determination is customarily not effected with a cloudiness test, but rather can be carried out, for example, by evaporating the liquid and weighing the remaining polymer or by one of the above analytical methods, such as ultrasound measurements, by means of IR, NIR, UV/Vis spectroscopy and also Raman spectroscopy.

According to the invention, it has been found that the propagation rate of an ultrasound wavetrain, the absorption behavior of electromagnetic radiation and also the emission measured by means of Raman methods changes with changing composition as a function of the medium, i.e. (meth)acrylic acid and/or (meth)acrylic ester or polymer, and thus enable detection or determination of polymer concentration.

Ultrasound measurements are carried out in a manner known per se by measuring the polymer content with the aid of the propagation rate of soundwaves. These propagate in solid, liquid and gaseous phase, so that measurements can be carried out in all states of matter.

The process according to the invention is preferably carried out in the liquid phase.

The equipment used in the process according to the invention is commercial ultrasound measurement instruments, for example from SensoTech GmbH, consisting of a probe which has a sender and a receiver. Such an instrument may, for example, be the LiquiSonic-30 ultrasound measuring instrument in combination with a LiquiSonic immersion probe reactor, Ser. No. 4682, protection class IP65, 1=60 cm, from Sensotech GmbH.

At a constant, instrument-specific separation between sender and receiver of the probe and also at a constant pressure and temperature, the sound velocity can be calculated from the measured running time of the ultrasound wavetrain and is directly proportional to the concentration of dissolved polymeric impurity. The amount of polymer deposited is related to the dissolved polymer concentration (FIG. 1).

The frequency range of the ultrasound wavetrain is probe-specific and is generally in the range from 1 to 2 GHz.

The preferred pressure range in which the measurements are carried out corresponds to the top pressure of the separating apparatus and is from 100 to 700 mbar, more preferably from 150 to 400 mbar.

The pressure at the measurement point varies typically by not more than 20 mbar, preferably not more than 10 mbar, more preferably not more than 5 mbar, most preferably not more than 2 mbar, from the value for which the calibration line was recorded.

The preferred measurement temperature in the separating apparatus is in the range between 20 and 100° C., preferably between 25 and 100° C., and most preferably between 30 and 95° C., and, in the region of the sidestream takeoffs, preferably between 80 and 90° C., the temperature at the measuring point varying typically by not more than 10° C., preferably not more than 5° C. and more preferably not more than 1° C., from the value for which the calibration curve was recorded.

The suitable sensor can be installed at any desired point in the production process, but preferably at points in which the medium to be analyzed is already liquid. The fluid is the condensable substances from the reaction gas or the condensable substances from the reaction gas absorbed in a liquid or a mixture of absorbing liquid and condensable substances from the reaction gas or the liquid reaction product of ester preparation whose composition has been modified by thermal or mechanical separating processes or feeding of further substances.

In a particularly preferred embodiment, the probe is installed in the distillation column or at points where the liquid from the distillation column flows past substantially unchanged.

Very particular preference is given to installing the analytical instrument at those points where the liquid to be analyzed is regularly exchanged by natural or forced convection.

A suitable sensor can, for example, be installed directly into the distillation column.

Equally, a suitable sensor can be mounted in a bypass of liquid-conducting internals in the separating apparatus.

In another form of the implementation of the process according to the invention, the sensor can be mounted in inlets or outlets to the separating apparatus.

It is equally possible to operate the detector as a “clamp-on” system, in other words not inline, through a suitable inlet, without the detector being immersed in the medium to be determined.

The composition of the mixture to be analyzed and also the quantitative content of (meth)acrylic acid and/or (meth)acrylic esters and also further secondary components and stabilizers or stabilizer mixture is unimportant for the process according to the invention and has no disrupting influence on the measurements. The water content at the measuring point is preferably from 50 to 1000 ppm, more preferably from 100 to 700 ppm and particularly preferably from 200 to 500 ppm.

The content of dissolved polymeric contamination at the measuring point is preferably within the concentration range below 5% by weight, preferably below 4% by weight, more preferably below 3% by weight and most preferably below 2.8% by weight, based in each case on (meth)acrylic acid and/or (meth)acrylic ester.

The concentration of dissolved polymeric impurity is determined under the conditions specified. The concentration of poly(meth)acrylic acid and/or poly(meth)acrylic ester [% by weight] and sound velocity [m/s] which can be calculated directly from the running time measured are linearly proportional. Linear regression provides a calibration curve which can be used to determine the content of dissolved polymer in the monomer.

As already mentioned, the concentration of dissolved polymer correlates directly to the amount of deposited polymer (FIG. 1).

It is also possible to determine the content of polymeric impurity by measuring the absorption coefficient in the infrared, near infrared, ultraviolet and/or visible region of the spectrum of electromagnetic radiation.

The process according to the invention uses commercial spectrometers. Such instruments include, for example, the Bruker ISF66 spectrometer having beam splitters of CaF (NIR), KBr (MIR) or quartz (UV/Vis) or a detector of InSb (NIR), DTGS (MIR) or Si diode (UV/Vis), which can analyze the near and middle wavelength range of the electromagnetic spectrum. When measuring the absorption spectra, the detector D413 can be used in the NIR range, the detector D301 in the IR range and the detectors D510 or D520 in the UV/Vis range, for example. The detectors mentioned are sold by Bruker.

The frequency range of the electromagnetic radiation for IR and NIR spectroscopy includes the complete IR range of the electromagnetic spectrum, i.e. the wavelength range of from 1 μm to 1 mm (cf. H. Günzler, H.-U. Gremlich, IR-Spectroscopy, An Introduction, Wiley-VCH, Weinheim, 2002, page 9 ff.), and that for UV/Vis spectroscopy includes the ultraviolet region (wavelength section from 200 to 400 nm) and the visible region (wavelength section from 400 to 800 nm).

The concentration of dissolved polymeric impurity is calculated with the aid of calibration curves which are recorded under the operating conditions or beforehand under controlled laboratory conditions. The amount of deposited polymer can be determined in a similar manner to the ultrasound measurements.

The measuring conditions such as pressure and temperature are, similarly to the ultrasound measurements, the operating conditions of the separating apparatus. The same applies as was said above.

The composition of the mixture to be analyzed and also the quantitative content of (meth)acrylic acid and/or (meth)acrylic esters and also further secondary components and stabilizers or stabilizer mixture is unimportant for the process according to the invention by measuring the absorption coefficient in the infrared, near infrared, ultraviolet and/or visible region of the electromagnetic spectrum and has no disrupting influence on the measurements. The water content at the measuring point is similar to the process using ultrasound methods.

The content of dissolved polymeric impurity at the measuring point is in the concentration range below 5% by weight, preferably below 4% by weight, even more preferably below 3% by weight and particularly preferably below 2.7% by weight, based-in each case on (meth)acrylic acid and/or (meth)acrylic ester.

That which was said for the ultrasound measurements applies similarly for the installation point of the IR, NIR or UV/Vis cells and/or probes.

It is possible to install such a measuring unit in a bypass of liquid-conducting internals of the column. Preference is given to using a flow cuvette in which a continuous noninvasive measurement is carried out.

In another form of the implementation, the measuring unit is installed in a bypass.

A further method according to the invention for determining the content of polymeric impurity is Raman spectroscopy.

Raman spectroscopy measurements are carried out in a known manner by determining the content of dissolved polymer with the aid of the emission of electromagnetic radiation. The Raman effect is based on the polarizability of the molecule during oscillation and is therefore particularly well suited to nonpolar or relatively nonpolar compounds, for example the C═C bond in (meth)acrylic acid and/or (meth)acrylic esters.

The process according to the invention uses commercial Raman spectrometers, for example from Bruker. Such an instrument may, for example, be the Bruker ISF66 spectrometer having an FRA106 Raman module.

As is known, the frequency range of the electromagnetic radiation is in the IR range of the electromagnetic spectrum (cf. general textbooks such as M. Hesse, H. Meier, B. Zeeh, Spektroskopische ethoden in der Organischen Chemie, Thieme Verlag, Stuttgart, 6th Edition, 2002, page 67 ff.), i.e. in the wavelength range from 1 μm to 1 mm.

The concentration of dissolved polymeric impurity is determined and the amount of polymer deposited is calculated in a similar manner to the measurements of the absorption coefficient of electromagnetic radiation. The amount of deposited polymer can be calculated in a similar manner to the ultrasound measurements.

The measuring conditions such as pressure and temperature are, similarly to the ultrasound measurements, the operating conditions of the separating apparatus. The same applies as was said above.

The composition of the mixture to be analyzed and also the quantitative content of (meth)acrylic acid and/or (meth)acrylic esters and also further secondary components and stabilizers or stabilizer mixture is unimportant for the process according to the invention by means of Raman spectroscopy and has no disrupting influence on the measurements. The water content at the measuring point is similar to the process using ultrasound methods.

The content of dissolved polymeric impurities at the measuring point is within the concentration range below 5% by weight, preferably below 4% by weight, even more preferably below 3% by weight and particularly preferably below 2.7% by weight, based in each case on (meth)acrylic acid and/or (meth)acrylic ester.

A Raman measuring unit is installed at the installation points specified in a similar manner to the ultrasound measurements or analytical methods such as IR, NIR and UV/Vis spectroscopy.

The analytical methods according to the invention enable precise control of the process, for example the determination of the type of stabilizer and the setting of the optimum amount of stabilizer. This is effected in a variant comparison of the measured values with the aid of the calibration curves. The content of polymer dissolved in the monomer determined in this way and the amount of deposited polymer calculated from it allows the determination of the type of stabilizer to be used and the calculation of the amount of stabilizer required to stabilize the (meth)acrylic acid and/or (meth)acrylic ester. This can be metered in or added, for example, controlled by a process control system.

It is also possible to precisely determine the economically optimum point in time for shutting down the plant for purification and thus overall to shorten the frequency of shutdown.

### EXAMPLE 1

Sound Velocity Measurements, Polyacrylic Acid in Acrylic Acid

To determine the polymer content, a concentration series of polyacrylic acid in acrylic acid is analyzed at 25° C. To this end, a flat-flanged flask is initially charged with acrylic acid and polyacrylic acid (Aldrich, Cat. No. 32,366-7, molecular weight approx. 2000 g/mol) is added in a plurality of steps. Once the solution is clear, the sound velocity is measured using a LiquiSonic-30 ultrasound measuring instrument in combination with a LiquiSonic immersion probe reactor, Ser. No. 4682, protection class IP65, 1=60 cm from SensoTech.

The measured points can be fitted using a linear function (FIG. 2: R²=0.9997). As a check, the values determined are plotted against the weights. The absolute error is max. 0.05%.

The addition of 500 ppm of phenothiazine does not influence the measurement.

### EXAMPLE 2

Raman Spectroscopy Measurements, Polyacrylic Acid in Acrylic Acid

25 sample mixtures are prepared of polyacrylic acid (Aldrich, Cat. No. 32,366-7, average molecular weight approx. 2000 g/mol) and acrylic acid stabilized by 200 ppm of hydroquinone monomethyl ether, within the concentration range of from 0.1 to 4.6% by weight of polyacrylic acid based on acrylic acid and analyzed in GC ampules using a Bruker ISF66 spectrometer with an FRA106 Raman module. The measurements are carried out with 200 scans.

For evaluation, the samples having the concentration ranges of from 0.1 to 2.7% by weight of polyacrylic acid are used. As a consequence of the distinct spectral differences resulting, inter alia, from the Cₐₗᵢₚₕ-H and C_{olef}-H vibrations, the following spectral regions are used for the evaluation: 3177 to 2797 cm⁻¹, 1788 to 1561 cm⁻¹ and 921 to 407 cm⁻¹. The absolute measurement error in the evaluated concentration range is at max. 0.3%.

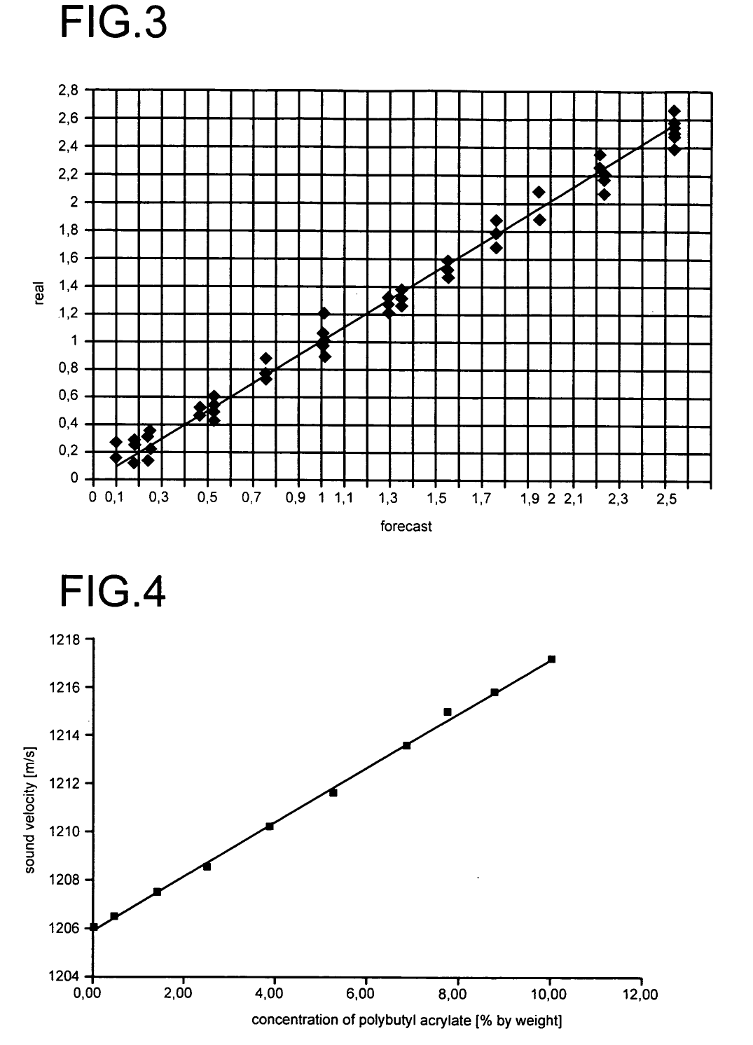

The evaluation of the samples analyzed (“real”) in comparison to the amounts of polyacrylic acid used (“forecast”) yields a straight line (FIG. 3, R²=0.9902) which serves for calibration and for evaluation of unknown mixtures.

### EXAMPLE 3

Restabilization at Onset of Polymerization Procedure When the Sound Velocity Rises

Double-distilled, unstabilized acrylic acid is admixed with 10 ppm of phenothiazine and stored under an air atmosphere in an oven at an internal temperature of 120° C. The samples are removed from the drying cabinet after 35 minutes (onset of pink coloration) and a solution of costabilizer is metered in within five minutes, so that there is a total concentration of 35 ppm of stabilizer. The samples are further heated at 120° C. and the time until complete, visible polymerization is determined.

It is found that the addition of different stabilizers to phenothiazine has a positive effect after the onset of stabilization (Table 1).

TABLE 1

| PTZ [ppm] | Costabilizer [25 ppm] | Time [min] | Factor |
|---|---|---|---|
| 10 | — | 78 | 1.00 |
| 10 | MeHQ | 75 | 0.96 |
| 10 | 4-HO-TEMPO | 193 | 2.47 |
| 10 | 4-MeO-TEMPO | 168 | 2.15 |
| 10 | PTZ | 80 | 1.03 |
| 10 | BHT | 84 | 1.08 |

PTZ=phenothiazine

MeHQ=methylhydroquinone

4-HO-TEMPO=4-hydroxy-2,2,6,6-tetramethylpiperidine N-oxyl

4-MeO-TEMPO=4-methoxy-2,2,6,6-tetramethylpiperidine N-oxyl

BHT=2,6-di-tert-butyl-4-methylphenol

### EXAMPLE 4

Sound Velocity Measurements, Polybutyl Acrylate in Butyl Acrylate

To determine the polymer content, a concentration series of polybutyl acrylate which is obtained by concentrating an approx. 50% solution in toluene (Aldrich, Cat. No. 18,140-4, average molecular weight approx. 99000 g/mol) in butyl acrylate (process composition of BASF Aktiengesellschaft, at least 99.7% pure) is analyzed at 25° C. To this end, a flat-flanged flask is initially charged with butyl acrylate and polybutyl acrylate is added in a plurality of steps. Once the solution is clear, the sound velocity is measured using a LiquiSonic-30 ultrasound measuring instrument in combination with a LiquiSonic immersion probe reactor, Ser. No. 4682, protection class IP65, 1=60 cm, from SensoTech.

The measured points can be fitted using a linear function (FIG. 4, R²=0.9994). As a check, the values determined are plotted against the weights. The absolute error is max. 0.05%.

We claim:

1. A process for determining the amount of polymer deposited from (meth)acrylic acid and/or (meth)acrylic esters, which comprises determining the concentration of dissolved polymer by measuring
a) the propagation rate of soundwaves and/or
b) the absorption coefficient in the infrared, near infrared, ultraviolet and/or visible region of the spectrum of electromagnetic radiation and/or
c) by means of Raman spectroscopy.

2. A process as claimed in claim 1, wherein the measurement is carried out in a thermal separating apparatus.

3. A process as claimed in claims 1 and 2, wherein the value measured is used to derive and adjust the type and amount of the stabilizer system.

4. A process as claimed in claim 3, wherein (meth)acrylic acid and/or (meth)acrylic ester is stabilized using compounds from the groups of the phenols, N-oxyl compounds, aromatic amines, phenylenediamines, imines, sulfonamides, oximes, oxime ethers, hydroxylamines, urea derivatives, phosphorus compounds, sulfur compounds, complexing agents based on tetraazaannulene and metal salts and/or mixtures of the groups mentioned.

5. A process as claimed in claims 1 and 2, wherein the measured value is used to derive the economically optimum point in time for stopping the separating process.

6. A process as claimed in claims 1 and 2, wherein the concentration of dissolved polymer is determined online invasively and/or noninvasively.

7. A process for determining the amount of polymer deposited from (meth)acrylic acid and/or (meth)acrylic esters, which comprises determining the concentration of dissolved polymer offline and invasively, with the proviso that no cloudiness test is carried out.

8. A process as claimed in claim 7, wherein the concentration of dissolved polymer is determined by measuring
a) the propagation rate of soundwaves and/or
b) the absorption coefficient in the infrared, near infrared, ultraviolet and/or visible region of the spectrum of electromagnetic radiation and/or
c) by means of Raman spectroscopy.
